(19) United States
(12) Patent Application Publication
(10) Pub. No.: US 2009/0165245 A1
(43) Pub. Date: Jul. 2, 2009

(54) SWING HINGE MODULE AND PORTABLE TERMINAL EMPLOYING THE SAME

(75) Inventors: Dong Joon KIM, Suwon-si (KR); Tae Hyong Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/328,288

(22) Filed: Dec. 4, 2008

(30) Foreign Application Priority Data
Dec. 27, 2007 (KR) 10-2007-0138332

(51) Int. Cl. E05F 1/08

(52) U.S. Cl. 16/277

(57) ABSTRACT

A swing hinge module having a simple structure and a movable body that swings, as well as a portable terminal having the same, are disclosed. The swing hinge module is installed between a fixed body and a movable body of the portable terminal to swing the movable body about a rotation shaft to be open from the fixed body. The swing hinge module includes a fixed plate coupled to the fixed body and having a first arc-shaped guide hole formed near the rotation shaft; and an elastic unit having a first end swingably coupled to the movable body and a second end, which is opposite the first end, movably coupled to the first guide hole to provide an elastic force to the movable body.

### CROSS REFERENCE TO RELATED APPLICATION

This application claims priority from and the benefit of Korean Patent Application No. 10-2007-0138332, filed on Dec. 27, 2007, which is hereby incorporated by reference for all purposes as if fully set forth herein.

### BACKGROUND OF THE INVENTION

1. Field of the Invention

The present invention relates generally to a portable terminal and, more particularly, to a swing hinge module having a simple structure and a movable body that swings, and a portable terminal having the same.

2. Discussion of the Background

In general, a mobile communication terminal refers to terminals, such as a personal mobile communication services terminal (PMCST), a personal digital assistant (PDA) terminal, a smart phone, an international mobile telecommunication (IMT)-2000 terminal, and a wireless local area network (LAN) terminal, that may realize various functions, such as a wireless communication function, using application programs, while being carried by a user.

Due to advances in communication technologies, mobile communication terminals have become compact and light-weight, and may be equipped with various services, such as an MP3 player service, a digital camera service, a navigation service, and an Internet access service. As a result, mobile communication terminals may function as complex communication terminals and are becoming necessities of modern society.

In addition, recently developed portable terminals may be equipped to receive satellite or terrestrial digital multimedia broadcasting (DMB), and in order to support this function, various swing-type portable terminals have been developed to conveniently open a display of the portable terminal to be positioned in the transversal direction.

In an existing swing-type portable terminal, the movable body may swing semi-automatically to open a display. However, the open movable body may need to be returned to its original position manually. Further, in the existing swing-type portable terminal, a swing hinge module swinging the movable body may have a very intricate structure. Thus, there may be a large number of parts included in the swing hinge module and the manufacturing costs may be high.

### SUMMARY OF THE INVENTION

The present invention provides a swing-type portable terminal that swings open and closed semi-automatically.

The present invention also provides a swing hinge module having a simple structure.

Additional features of the invention will be set forth in the description which follows, and in part will be apparent from the description, or may be learned by practice of the invention.

The present invention discloses a swing-type portable terminal including a fixed body, a movable body coupled to the fixed body, and a swing hinge. The movable body is swingable about a rotation shaft. The swing hinge module includes an elastic unit having a first end swingably coupled to the movable body and a second end, which is opposite the first end, movably coupled to the fixed body to provide an elastic force to the movable body.

The present invention also discloses a swing hinge module including a rotation shaft, a fixed plate having a first guide hole near the rotation shaft, and an elastic unit having an end movably coupled to the first guide hole.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A and FIG. 1B are schematic views respectively showing a normal state and a swung state of a portable terminal having a swing hinge module according to an exemplary embodiment of the present invention.

FIG. 2 is an exploded perspective view showing the coupling between the portable terminal according to an exemplary embodiment of the present invention and a swing hinge module.

FIG. 3A, FIG. 3B, FIG. 3C, FIG. 3D, and FIG. 3E are views showing the operation of the swing hinge module according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Hereinafter, embodiments of the present invention will be described in detail with reference to the accompanying drawings. In the description, a portable terminal basically refers to a swing-type portable terminal.

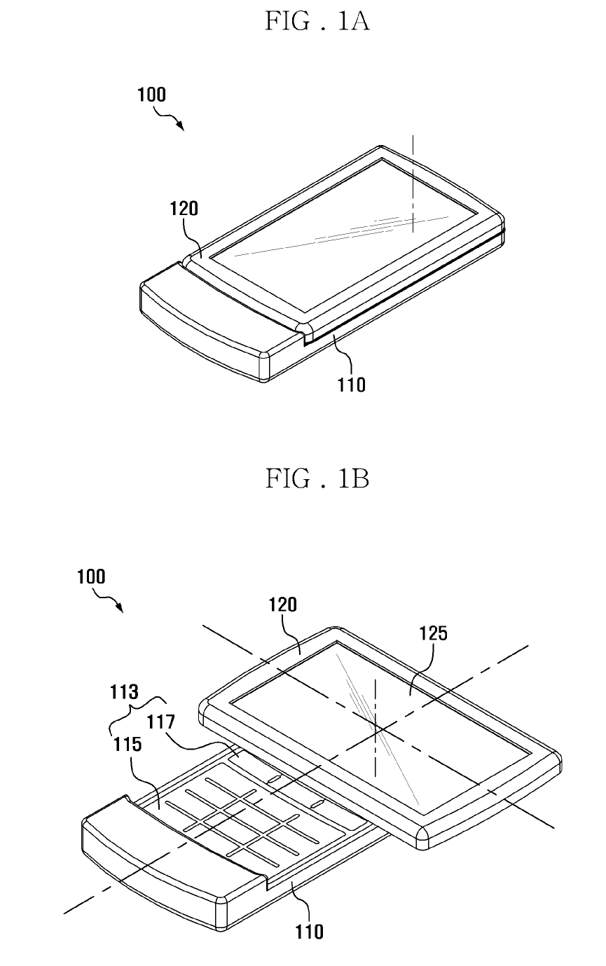

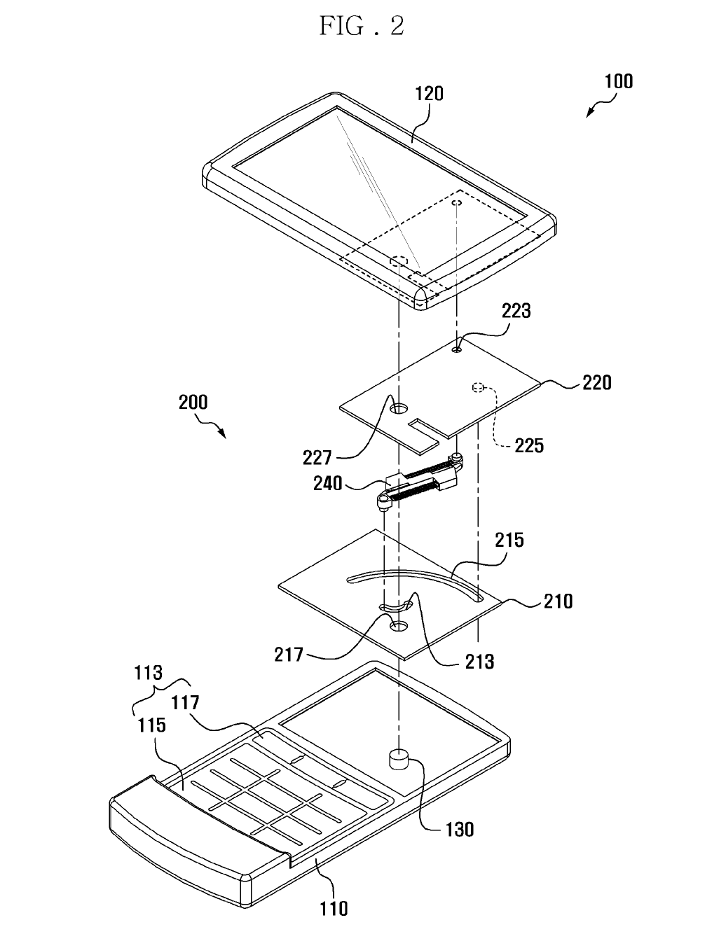

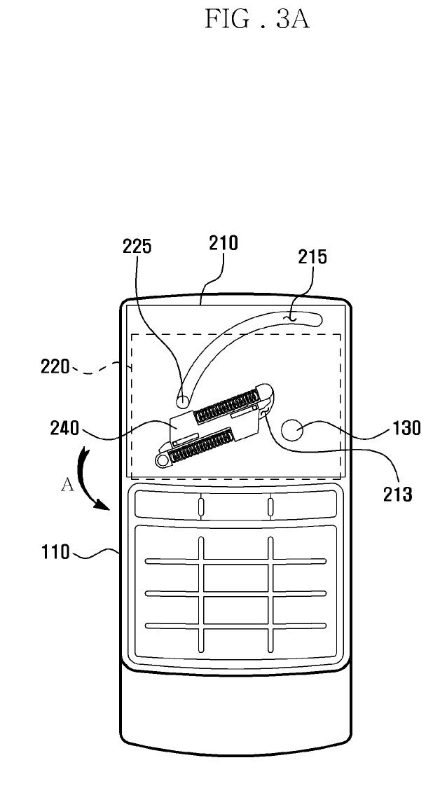

FIG. 1A and FIG. 1B are schematic views respectively showing a normal state and a swung state of a portable terminal having a swing hinge module according to an embodiment of the present invention, and FIG. 2 is an exploded perspective view showing the coupling between the portable terminal and a swing hinge module.

Referring to FIG. 1A, FIG. 1B, and FIG. 2, a portable terminal 100 according to an exemplary embodiment of the present invention includes a fixed body 110, a movable body 120, and a swing hinge module 200.

The fixed body 110 does not swing and includes a battery and a key input unit 113 through which numbers and characters are input to the portable terminal 100. The key input unit 113 may include alphanumeric keys to input alphanumeric characters and function keys 117 to input various commands and controls.

The movable body 120 is swings about a rotation shaft 130 when manipulated by a user and includes a display device 125, such as an LCD, of the portable terminal 100. Thus, the movable body 120 is coupled to the fixed body 110 to swing on the fixed body 110 about the rotation shaft 130. The rotation shaft 130 may be coupled to the movable body 120 such that a first end thereof is coupled to the fixed body 110 and a second end thereof, which is opposite the first end, is coupled to the movable body 120 through a bearing. The rotation shaft 130, as shown in FIG. 2, is arranged at a position between the center of the fixed body 110 and a side of the fixed body 110 (for example, to the right side of the center of the fixed body 110). The shift is to position the center of the movable body 120 at the center of the fixed body 110 during the swinging of the movable body 120. By doing so, the center of the movable body 120, as shown in FIG. 1B, is aligned with the center of the portable terminal 100 after the movable body 120 swings.

The swing hinge module 200 provides an elastic force to semi-automatically swing the movable body 120, and includes a movable plate 220, a fixed plate 210, and an elastic unit 240.

The movable plate 220 is fixed to the movable body 120 and swings together with the movable body 120. The movable plate 220 is coupled with a first end of the elastic unit 240, which is described below, to be rotated. To this end, the movable plate 220 includes a fixing hole 223 with which the first end of the elastic unit 240 is coupled, and a through-hole 227 through which the rotation shaft 130 passes. The movable plate 220 includes a guide pin 225 protruding from an opposite side of the movable plate 220 toward the fixed plate 210. The guide pin 225 is inserted into a second guide hole 215 of the fixed plate 210, which is described below, and moves along the second guide hole 215 when the movable body 120 swings.

A side of the fixed plate 210 is coupled to the fixed body 110. The fixed plate 210 has a first guide hole 213 with which a second end of the elastic unit 240 is coupled to move along, a second guide hole 215 with which the guide pin 225 is inserted into and moves along, and a through-hole 217 through which the rotation shaft 130 passes.

The first guide hole 213 is formed near the rotation shaft 130 in a small arc-shape facing the second guide hole 215. The second end of the elastic unit 240 moves along the first guide hole 213 when the movable body 120 swings.

The second guide hole 215 is formed in an arc-shape having the same center as that of the rotation shaft 130. As described above, the guide pin 225 moves along the second guide hole 215 when the movable body 120 swings. A length of the second arc-shaped guide hole 215 is equal to a rotational distance of the movable body 120. In the portable terminal 100 according to an exemplary embodiment of the present invention, the movable body 120 swings only within 90 degrees of its initial position on the fixed body 110. Thus, the second guide hole 215 extends to a point where the guide pin 225 is after the movable body 120 has swung 90 degrees about the rotation shaft 130. A rotation angle of the movable body 120 is restricted to 90 degrees by the second guide hole 215 and the guide pin 225 inserted thereinto.

In this exemplary embodiment, the first end of the rotation shaft 130 is fixed to the fixed body 110 and the second end thereof passes through the through-holes 217 and 227 of the fixed plate 210 and the movable plate 220 to be swingably coupled to the movable body 120. Alternatively, the first end of the rotation shaft 130 may be directly fixed to the fixed plate 210 and the second end thereof may be swingably coupled to the movable plate 220.

The first end of the elastic unit 240 is coupled with the fixing hole 223 of the movable plate 220. In this case, the first end of the elastic unit 240 is inserted into and rotatably coupled to the fixing hole 223. The second end of the elastic unit 240 is inserted into the first guide hole 213 of the fixed plate 210 to move. The second end of the elastic unit 240 provides an elastic force to the movable body 120 during the swinging of the movable body 120. To this end, the elastic unit 240 provides an elastic force to push the movable body 120 away from the rotation shaft 130. In this exemplary embodiment, the elastic unit 240 may be a slide spring that is linearly extended and compressed to provide an elastic force. In more detail, the slide spring may be a push rod having tension springs respectively installed at opposite ends thereof to provide a linear elastic force. However, the slide spring is not limited thereto. Various elastic bodies such as compression springs, torsion springs, and the like, may be used in place of the tension springs to provide an elastic force to the movable body 120.

The elastic unit 240 is coupled to the fixed plate 210 and the movable plate 220 while the springs are compressed. Thus, the elastic unit 240 continuously provides an elastic force to the movable body 120.

Operation of the portable terminal 100 having the swing hinge module 200 according to an exemplary embodiment of the present invention will be described as follows.

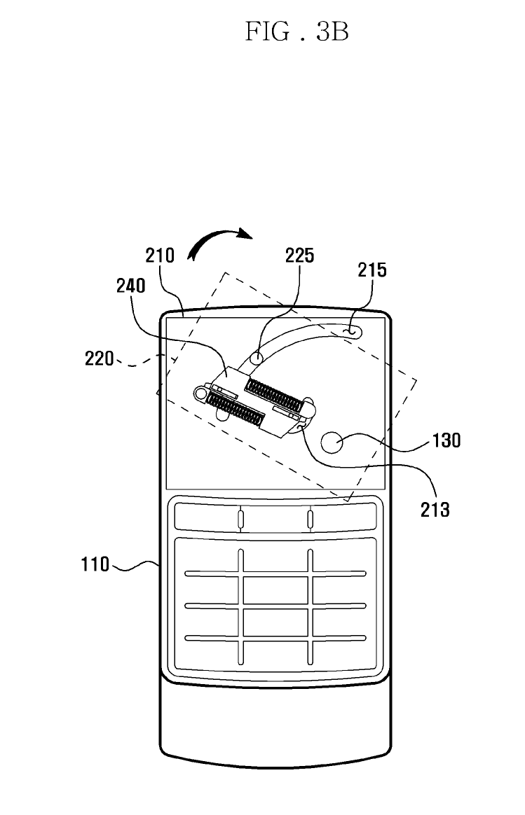

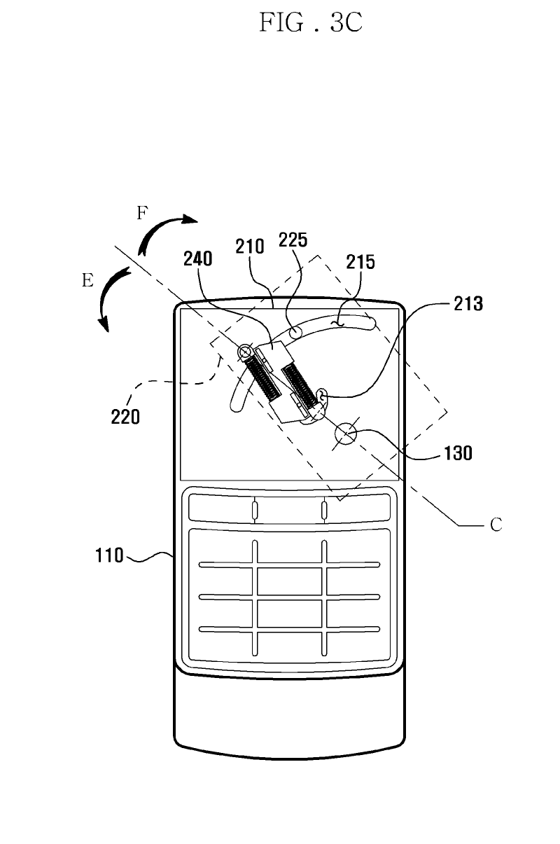

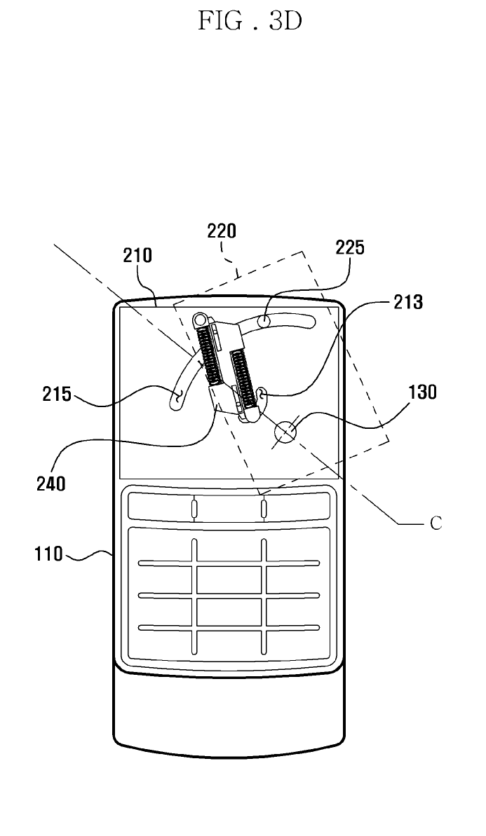

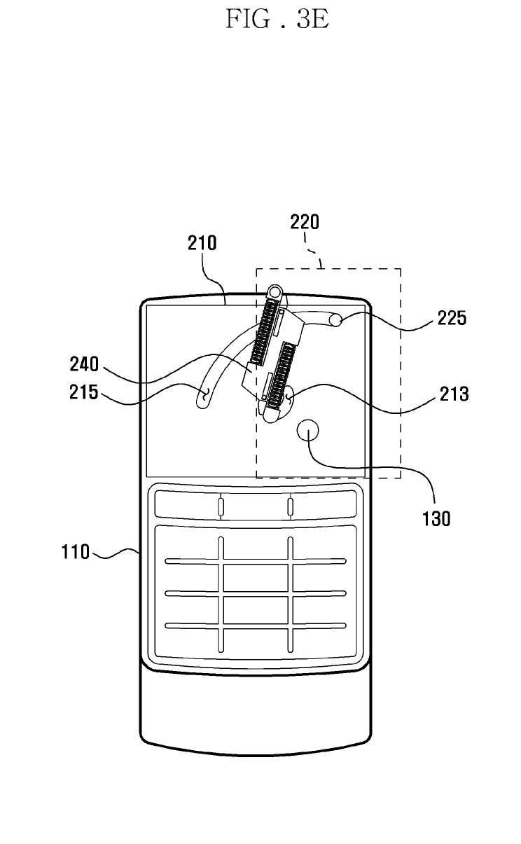

FIG. 3A, FIG. 3B, FIG. 3C, FIG. 3D, and FIG. 3E are perspective views respectively showing a swing operation of the swing hinge module 200 according to an exemplary embodiment of the present invention.

Referring to FIG. 1, FIG. 2, FIG. 3A, FIG. 3B, FIG. 3C, FIG. 3D, and FIG. 3E, the portable terminal 100 according to an exemplary embodiment of the present invention is in a basic state depicted in FIG. 3A (a state depicted in FIG. 1A) before the movable body 120 is swung. In other words, the second end of the elastic unit 240 is positioned at the uppermost end of the first guide hole 213, and the guide pin 225 is positioned at the lowermost end of the second guide hole 215. In this state, the elastic unit 240 provides the elastic force to move the movable body 120 about the rotation shaft 130. A force in direction A is exerted on the movable body 120. However, since the guide pin 225 is positioned at the lowermost end of the second guide hole 215, the movable body 120 does not swing further and maintains the fixed state. As such, in the portable terminal 100 according to an exemplary embodiment of the present invention, the movable body 120 may be stably fixed in the basic state by the elastic force from the elastic unit 240, the movable plate 220, and the guide pin 225.

When the user applies a force to the movable body 120 to use the portable terminal 100, the movable body 120 swings clockwise or counterclockwise due to the force by the user. While the movable body 120 swings, the first end of the elastic unit 240 coupled to the movable body 120 and the guide pin 225 move together.

As the movable body 120 swings, as shown in FIG. 3B, the length of the elastic unit 240 is shortened. This is because a distance between ends of the elastic unit 240, that is, between the fixing hole 223 of the fixed plate 220 and the first guide hole 213 of the fixed plate is shortened. Due to the shortened distance, the elastic unit 240 may be further compressed, thereby providing a stronger elastic force to the movable body 120. The second end of the elastic unit 240 moves within the first guide hole 213 away from the end of the elastic unit 240 due to the elastic force. Thus, the second end of the elastic unit 240 positioned at the uppermost end of the first guide hole 213, as shown in FIG. 3A, moves to the central area of the first guide hole 213, as shown in FIG. 3B.

As such, when the movable body 120 swings, the guide pin 225 moves along the second guide hole 215 and the second end of the elastic unit 240 moves along the first guide hole 213 in a direction opposite to the movement of the guide pin 225.

Next, in the state shown in FIG. 3B, when the user continuously provides a force to the movable body 120, the movable body 120 continues swinging and a state shown in FIG. 3C is achieved.

As shown in FIG. 3C, the rotation shaft 130 and both ends of the elastic unit 240 are arranged on the same line (hereinafter, referred to as a critical line C). In this case, the elastic unit 240 may be maximally compressed and provides the strongest elastic force.

When, in the state of FIG. 3C, the movable body 120 swings slightly in direction E or direction F, the elastic unit 240 swings the movable body 120 in the corresponding direction using the strong elastic force. In other words, although the user should apply a force to the movable body 120 to swing it to the state as shown in FIG. 3C, once the state as shown in FIG. 3D is achieved, the movable body 120 automatically swings due to the elastic force from the elastic unit 240 until it reaches the state shown in FIG. 3E.

When the movable body 120 swings to reach the state shown in FIG. 3E, the guide pin 225 moves to the utmost right side of the second guide hole 215 and is fixed at that position. In this state, since the guide pin 225 does not further move within the second guide hole 215, the movable body 120 cannot swing further. When the movable body 120 reaches this state, the display device 125 thereof is transversely positioned as shown in FIG. 1B. In this case, central lines of the movable body 120 and the display device 125 are perpendicular to a central line of the fixed body 110.

When the movable body 120 swings and the display device 125 is transversely positioned, the user may easily view DMB, a moving picture, and the like using the display device 125.

The movable body 120 may be returned to its original position, that is, the basic state, as follows.

When the user pushes the movable body 120 in the opposite direction, that is, in the counterclockwise direction, the movable body 120 swings accordingly. In other words, the movable body 120 swings from the state shown in FIG. 3E to the states shown in FIG. 3D, FIG. 3C, FIG. 3B, and FIG. 3A, sequentially.

The user applies a force to the movable body 120 in the state shown in FIG. 3E such that the movable body 120 swings until reaching the state shown in FIG. 3C where both ends of the elastic unit 240 are positioned on the critical line C. When the first end of the elastic unit 240 passes through the critical line C over the state shown in FIG. 3C, the movable body 120 automatically swings due to the elastic force even in the absence of the force applied by the user. Then, the movable body 120 swings to return to the basic state shown in FIG. 3A.

As described above, in the swing hinge module according to an exemplary embodiment of the present invention and the portable terminal having the same, the movable body 120 is swung by the swing hinge module including the elastic unit, the movable plate having the guide pin, and the fixed plate having the second guide hole to which the elastic unit is coupled to move and the first guide hole to which the guide pin is coupled to move. The swing hinge module according to an exemplary embodiment of the present invention is configured with a minimum number of parts including the elastic unit, the movable plate, and the fixed plate. Thus, the time needed to assemble the swing hinge module may be reduced during the manufacturing process and the costs for the parts may be saved.

Moreover, since the movable body is semi-automatically driven by the elastic force from the elastic unit whenever the movable body swings about the fixed body to open and close, user convenience may increase.

Although a case where the first and second guide holes are formed in the fixed plate is described in the above-mentioned exemplary embodiment of the present invention, the second guide hole may be formed in the movable plate. If the second guide hole is formed in the movable plate, the guide pin is fixed on the fixed plate and it is preferred that the guide pin is not coupled at the position to which the guide pin is coupled as described in the above-mentioned exemplary embodiment (the lowermost end of the second guide hole in the basic state), but at the opposite position (the utmost right side of the second guide hole in the basic state).

Although the swing hinge module is installed in the portable terminal in the above-mentioned exemplary embodiment of the present invention, the swing hinge module may be installed in any devices having a fixed body and a movable body swinging on the fixed body.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A swing-type portable terminal, comprising:
a fixed body;
a movable body coupled to the fixed body, the movable body being swingable about a rotation shaft; and
a swing hinge module comprising an elastic unit, the elastic unit comprising a first end swingably coupled to the movable body and a second end, which is opposite the first end, movably coupled to the fixed body.

2. The swing-type portable terminal of claim 1, wherein the elastic unit provides an elastic force to the movable body.

3. The swing-type portable terminal of claim 2, wherein the elastic unit comprises a slide spring that is linearly extended and compressed to provide the elastic force.

4. The swing-type portable terminal of claim 2, wherein the swing hinge module further comprises:
a movable plate coupled to the movable body to swing with the movable body, and coupled to the first end of the elastic unit; and
a fixed plate coupled to the fixed body and comprising a first guide hole to which the second end of the elastic unit is coupled.

5. The swing-type portable terminal of claim 4, wherein the fixed plate further comprises a second guide hole, the second guide hole being an arc-shaped guide hole, and the rotation shaft being disposed to correspond to a center position of the second guide hole.

6. The swing-type portable terminal of claim 5, wherein the movable plate further comprises a guide pin comprising a first end coupled to the movable plate and a second end, which is opposite the first end, movably coupled to the second guide hole of the fixed plate.

7. The swing-type portable terminal of claim 6, wherein the first guide hole has an arc shape facing the second guide hole and is smaller than the second guide hole.

8. The swing-type portable terminal of claim 7, wherein the guide pin moves along the second guide hole, and the second end of the elastic unit moves along the first guide hole in a direction opposite to movement of the guide pin when the movable body swings.

9. The swing-type portable terminal of claim 7, wherein the movable body is restricted within 90 degrees of its initial position by the second guide hole.

10. The swing-type portable terminal of claim 7, wherein the rotation shaft is arranged at position between the center of the fixed body and one of a right side and a left side.

11. A swing hinge module of a portable terminal, comprising:
a rotation shaft;
a fixed plate comprising a first guide hole formed near the rotation shaft; and
an elastic unit comprising a first end movably coupled to the first guide hole

12. The swing hinge module of claim 11, wherein the elastic unit provides an elastic force.

13. The swing hinge module of claim 12, wherein the elastic unit comprises a slide spring that is linearly extended and compressed to provide the elastic force.

14. The swing hinge module of claim 12, further comprising a movable plate swingably coupled to a second end of the elastic unit.

15. The swing hinge module of claim 14, wherein the fixed plate further comprises a second guide hole, the second guide hole being an arc-shaped guide hole, and the rotation shaft being disposed to correspond to a center position of the second guide hole, and
wherein the movable plate further comprises a guide pin comprising a first end coupled to the movable plate and a second end, which is opposite the first end, movably coupled to the second guide hole.

16. The swing hinge module of claim 15, wherein the guide pin moves along the second guide hole and the first end of the elastic unit moves along the first guide hole is a direction opposite to movement of the guide pin.

17. The swing hinge module of claim 15, wherein the movable plate is restricted to within 90 degrees of its initial position by the second guide hole.
